(19) United States
(12) Patent Application Publication
(10) Pub. No.: US 2011/0035174 A1
(43) Pub. Date: Feb. 10, 2011

(54) TIME SYNCHRONIZATION IN AN IMAGE PROCESSING CIRCUIT

(75) Inventors: Anirban Lahiri, Kolkata (IN); Alexander Alexandrovich Danilin, Eindhoven (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/936,457

(22) PCT Filed: Apr. 7, 2009
(86) PCT No.: PCT/IB09/51464

§ 371 Date: Oct. 5, 2010

(30) Foreign Application Priority Data
Apr. 7, 2008 (EP) 08103410.0
Apr. 7, 2009 (IB) PCT/IB2009/051464

(51) Int. Cl. G01C 11/02

(52) U.S. Cl. 702/94

(57) ABSTRACT

A controllable light source (102) is controlled to emit modulated light, preferably using a uniquely recognizable modulation pattern. A plurality of camera units (10) captures images that contain the light source. Clock time values at a time corresponding to capture of the image are captured from respective clock circuits (120) associated with the camera units (10) that capture the images. The modulated light is detected in the captured images. Relative calibration of the clock circuits (120) with respect to each other is performed using the associated clock time values of the images wherein the modulated light is detected.

### FIELD OF THE INVENTION

The invention relates to a system comprising a plurality of cameras for measuring properties of visible objects, to a camera unit for use in such a system, to a method of calibrating such a camera system and to a method of measuring a property of a visible object and to a computer program product for executing such a method.

### BACKGROUND OF THE INVENTION

It is known to measure the position of a visible object using a plurality of cameras that may view the object from different angles. Calibration is an important issue in the design of such a system. Calibration involves the determination of the relative position and orientation of the cameras.

U.S. patent application Ser. No. 2005/0071105 describes how calibration can be performed by moving a point of light along a circle in a plane, from where it is visible from different cameras for at least part of the time.

U.S. patent application Ser. No. 2006/0195292 also describes how calibration can be performed using images of a shared object from different cameras. This document notes that the synchronization of image sampling by the cameras gives rise to several problems. The image sampling time points of different cameras may not be synchronized, and they may be measured by different clocks. The document proposes to correct for the clock differences by adding time offsets to clock time values, and to correct for sampling time differences by interpolation of data from the same camera for adjacent sampling time points. However, no method of determining the time offsets is discussed.

### SUMMARY OF THE INVENTION

Among others, it is an object to provide for object property measurement with a plurality of cameras, wherein calibration is simplified.

Among others, it is an object to provide for improved relative calibration of cameras.

An image processing system according to claim 1 is provided. Herein a plurality of clock circuits and camera units are present. Each camera unit has an associated clock circuit. Processing circuitry is coupled to the camera units and a controllable light source. The processing circuitry causes the controllable light source to emit modulated light, detects the modulated light in captured images from the camera units and determine a relative calibration of the clock circuits with respect to each other from associated clock time values of the images wherein the modulated light is detected.

In an embodiment the controllable light source is located in a camera unit, so that the clock time value of the associated clock of the camera unit at a time of emission of the modulated light may also be captured and used to contribute to calibration.

In an embodiment a plurality of controllable light sources may be used, each for emission of modulated light, so that emissions form different positions can be used for the calibration. In a further embodiment modulation patterns may be used that distinguish each controllable light source from all other ones of the other ones of the controllable light sources. Thus, it is made possible to identify different light sources from the captured images, for use in respective parts of the calibration. Modulation patterns representing respective different codewords of an error correcting code may be used to distinguish the light sources.

### BRIEF DESCRIPTION OF THE DRAWINGS

These and other advantageous aspects will become apparent from a description of exemplary embodiments, using the following Figures.

FIG. 1 shows a system with a plurality of cameras

FIG. 1a shows a front view of a camera

FIG. 2 shows a camera configuration

FIG. 3 shows examples of temporal emission patterns

### DETAILED DESCRIPTION OF EXEMPLARY EMBODIMENTS

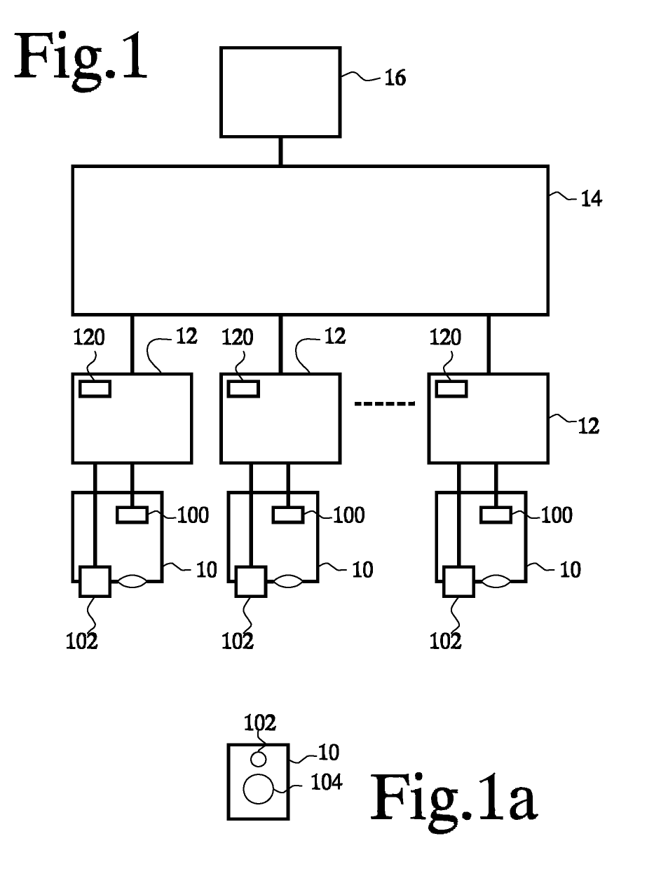

FIG. 1 schematically shows a system with a plurality of cameras 10. The system comprises cameras 10, camera control circuits 12, a communication network 14 and a common processor 16. Each camera control circuit comprises a clock circuit 120. Camera control circuits 12 are each coupled to respective one of the cameras 10. The camera 10 and the camera control circuit 12 together may form one camera unit, but alternatively, the camera may form a separate camera unit.

Camera control circuits 12 are coupled to common processor 16 via communication network 14 via a network interface of the camera control circuit 12. Any type of network interface may be used, such as a wireless interface, an Ethernet interface, a telephone line etc. Common processor 16 may be configured to compute three dimensional position information from the data obtained from combinations of different cameras 10. Common processor 16 may be configured to compute further images in response to the data, for display on one or more display screens (not shown) and/or to control actuators (not shown) dependent on the data.

Communication network 14 may be a network that transmits messages with unpredictable variable delays, dependent for example on the location of message sources and destinations and/or other message traffic. The system is robust against effects of such unpredictable delays on image processing. However, it should be noted that the system can be used even if communication network 14 has no unpredictable delays. As long as it is not known whether communication network 14 has unpredictable delays, for example because the type of communication network 14 will be selected arbitrarily by a user after design of the system, robustness against such effects is desirable.

Although three cameras 10 with corresponding camera control circuits 12 are shown by way of example, it should be realized that two, or more than three, cameras 10 and camera control circuits 12 may be used. Each camera 10 comprises an image sensor 100 and a controllable light source 102 coupled to its camera control circuit 12. Light source 102 may be a LED for example. Fig. la shows an exemplary front view of a camera 10, with light source 102 and a lens 104, for imaging the region of interest onto the image sensor (not shown). In an embodiment, light source 102 has a predetermined, fixed position relative to lens 104.

It should be realized that FIG. 1 is not informative about the actual position and orientation of the cameras: although the cameras are shown in a row and directed parallel in order to show the system schematically, their actual position and orientation will be different. Moreover, it should be realized that some camera control circuits 12 may be coupled to a group of cameras and that common processor 16 may be coupled directly to some camera control circuits, without intervening communication network 14.

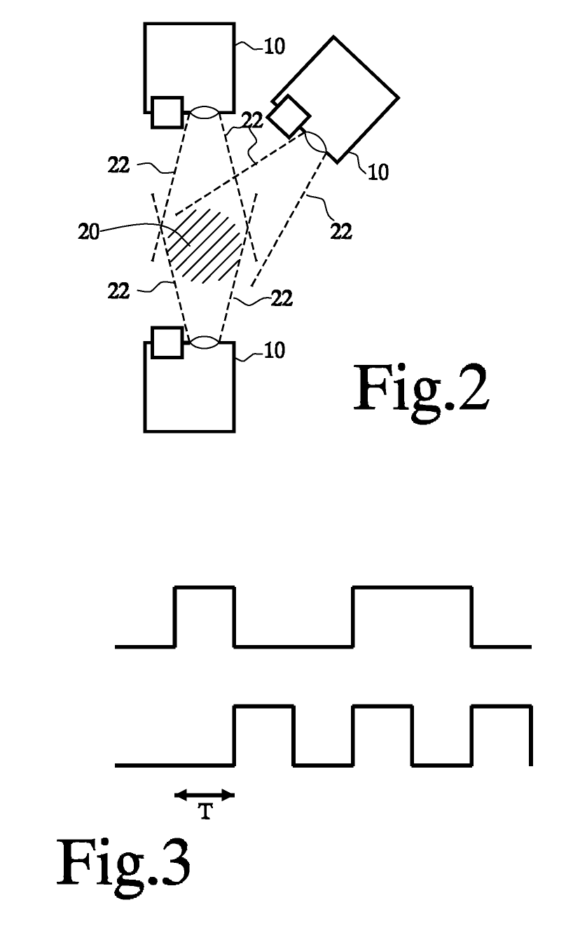

FIG. 2 shows an example of a camera configuration, comprising a plurality of cameras 10, directed at a region of interest 20. The field of view of different cameras 10 is indicated by dashed lines 22. It should be noted that various cameras 10 are in the field of view of other cameras 10. It should be emphasized that the Figure shows merely one example of a configuration. Cameras 10 may be provided at any angle and any relative position. Also it is not necessary that each camera 10 has all other cameras in its field of view. Each particular camera 10 will have a viewing group of one or more of the other cameras 10 that have the particular camera in their field of view. The viewing groups of different cameras 10 may be mutually different and some cameras 10 may be absent from viewing groups of part of the other cameras 10.

In operation common processor 16 and camera control circuits 12 perform a collection of processing tasks. Part of these tasks have to be performed at specific camera control circuits 12, but other tasks are migratable in the sense that the may be performed by any one of the common processor 16 and camera control circuits 12. As far as such migratable tasks are concerned, common processor 16 and camera control circuits 12 will collectively be referred to as processing circuitry. In fact common processor 16 may even be omitted, all tasks being performed by the camera control circuits 12, or common processor 16 may comprise a plurality of sub-processors that may separately be coupled to communication network 14. In each case, the camera control circuits 12, the common processor 16 if any and the sub-processors are collectively referred to as the processing circuitry.

In operation cameras 10 capture images of the region of interest 20 and transmit data obtained from the captured images through communication network 14. The processing circuitry sends command messages to camera control circuits 12 through communication network 14, to control light sources 102 to emit patterns of time-varying light intensity. In response to received command messages, each camera control circuit 12 controls the light intensity of the controllable light source 102 of the camera 10 that it is connected to. A pattern with on/off levels may be used.

FIG. 3 shows examples of emission patterns as a function of time. In each pattern the light source 102 is switched between an on level and an off level, and kept at each level during at least a video frame period T (two video fields) of the camera 10. Longer minimum time intervals may be used, such as time intervals of two frame durations. Instead of keeping the light source 102 on during an entire video frame or field, light source 102 may be flashed on temporarily during a field period in a pulse that is shorter than a video frame or field, successive pulses being separated by at least a frame or field duration. When the camera 10 integrates received light over a frame or field this makes no difference for reception when to synchronized emission and reception are used, but a higher time resolution is possible in the case of non-synchronized emission and reception.

Further during operation, camera control circuit 12 determines a clock time value of its clock circuit 120 at a time of emission of the pattern and transmits a response representing this clock time value through communication network 14. Each camera 10 captures images that contain pixels receive light from the light sources of those of the other cameras 10 that are in its field of view. In addition camera control circuit 12 captures clock time values of the clock circuit 120 at least for images that contain the emission pattern.

This may be done by capturing clock time values for all images and subsequently detecting in the processing circuitry which of the images contain the emission pattern or by first detecting images that contain the emission pattern in a camera control circuit and then sampling the clock time of the clock circuit 120 for the detected images.

Detection of the images that contain the emission pattern may be performed by detecting whether there is a pixel location at which the pattern occurs in the pixel values of the pixel location in a series of successive images. Use of detection for individual pixel location has the advantage that a maximum signal to noise ratio can be realized. Alternatively, detection may be performed by detecting whether the pattern occurs in successive spatial averages (or spatial sums) over a group of pixels in a series of successive images. In this case the pattern may be detected in the image if the pattern is detected in any group in the image. The entire image may be used as a group, or a block of pixel locations. Use of an average (sum) of over pixel values for a group of pixel locations has the advantage that fewer computations are required. However, it results in the addition of an amount of background that must be accounted for during detection, and which may make detection more difficult due to motion in the images or rounding errors.

Accordingly, the processing circuitry monitors the images for temporal variations corresponding to the emission pattern, to detect temporal variations due to the patterns. When such a pattern is detected, the clock time value of the clock circuit 120 of the camera control circuit 12 of the camera 10 that captured the image at the time when the pattern occurred is determined. This clock time value is communicated through communication network 14.

In this way, the processing circuitry receives clock time values corresponding to the time of emission of the pattern of time-varying light intensity from a plurality of camera control circuits 12, including the camera control circuit 12 of the camera 10 that emitted the pattern and one or more camera control circuits 12 of cameras 10 that captured the pattern. From the received information the processing circuitry determines relative clock offsets between the camera control circuits 12 for a set of cameras that contains the emitting camera 10 and the viewing group of the emitting camera 10. In other words, the clock offsets of all cameras 10 in the set to a reference camera in the set may be determined. This may be repeated for other emitting cameras 10, to obtain relative offsets for other sets of cameras 10. When there are overlaps between these sets, which allow sets that cover all cameras 10 to be linked, the relative offset of all cameras 10 can be defined in this way.

In this embodiment both the captured clock time values of the camera control circuit 12 of the camera 10 that emitted the pattern and of the one or more camera control circuits 12 of cameras 10 that captured the pattern are used. Alternatively, subsets of these clock time values may be used, for example only the clock time values of the cameras 10 that captured the pattern and not the clock time value of the emitting camera 10. However, it is preferred to use the clock time values of the cameras 10 that captured the pattern, as this clock time value can be determined with little processing. Furthermore, it is preferred to use clock time values from as many cameras 10 as possible, because this increases the coverage of different cameras 10. Thus, even if one camera 10 does not view any other camera 10, it clock circuit can be calibrated as long as at least one other camera 10 has this camera 10 in view. A set of relative offsets may be selected that minimizes the sum over all light sources of the variances of observations of the light source. Herein the variance for a light source is the difference between the average of squares (ti+di)² of the sampled clock time ti value at a camera “i” at the time of emission from the light source plus the offset for the camera “i”, averaged over all cameras minus the square of the average of (ti+di). Herein one offset may arbitrarily be fixed when the offsets di are selected that minimize this sum.

In an embodiment mutually different patterns of time-varying light intensity may be emitted from different cameras, so that each pattern distinguishes the camera 10 that emits the pattern from all other cameras 10. In this embodiment, the processing circuitry detects for each of the patterns whether the patterns has occurred in the images. This allows the emitting camera to be identified from the captured images, so that the clock time value at which a pattern is detected can be combined with an identification based on the pattern.

In a further embodiment, a redundant pattern may be used, which allows the timing to be determined even if light from a light source is erroneously missed in some images, or light is falsely detected in some images. Thus, for example, light source 102 may be kept on or off in each video frame of a series of successive video frames, according to some redundant pattern, or flashed on during selected pulse intervals according to the pattern.

Different codewords from an error correcting code may be used to define the pattern of emission by the light sources 102 of different cameras 10 for example. This ensures that there sufficient difference between the patterns to identify a pattern even it is corrupted in the captured images. Moreover, it makes it possible to use well developed techniques for error correction to recover the original code word, timing information and also the emitting camera 10 can be identified. In this case, any form of error correcting decoding may be applied to pixel values or averages from the camera images to detect whether, after correction, pixel values of a pixel in successive frames correspond to a codeword used by a specific camera 10. Viterbi decoding may be used for example.

Alternatively, the cameras may be activated to emit the patterns in turn, in well separated time intervals, in which case the cameras can be identified from the time interval in which the pattern is detected. No distinguishing pattern is needed in this case, so that the same pattern may be emitted from all cameras. In this case a simple pattern may be used, for example a pattern wherein light source 102 is switched on during a predetermined of frame periods. In this case, the clock time values may be determined by sampling the clock circuit at the end of the first or last video frame in which the pattern was detected. However, also in this case a redundant pattern may be used to reduce the susceptibility to errors.

When a redundant pattern is used to reduce the susceptibility to errors, be it in the case of patterns that distinguish specific cameras 10 or shared by different cameras, correlation may be used to detect the time point of capturing emission. The correlation of an expected pattern with observed pixel intensity in successive captured frames will result in a correlation peak and the clock time value at the position of this correlation peak can be used to represent timing of a camera control circuit 12.

Many patterns are suitable for this purpose and any known correlation technique may be used. In an embodiment random patterns may be used. The pattern may be run-time selected and distributed for use in emission and correlation. Predetermined random patterns may be used. If a predetermined pattern is used, distribution of the pattern may not be needed.

When each pattern distinguishes a specific camera 10 that emits the pattern, the patterns may be emitted by different cameras 10 simultaneously, or a time separation that is smaller than delay variation introduced by communication network 14. If the pattern is not distinguishing then the emitting camera may be made identifiable by using a time separation between indistinguishable emissions that is larger than delay variation introduced by communication network 14. However, this means that the determination of the offsets takes more time than in the case of unique signals.

Once the offsets between the clock time of different camera control circuits 12 has been determined, the offset can be used to coordinate timing of the cameras. In one embodiment, the processing circuitry sends clock correction data to the camera control circuits 12 based on the offset. In this embodiment the camera control circuits 12 change their clock time according to the offset. In an alternative embodiment, the clock circuits may be unaffected, their clock time values being corrected according to the offsets after clock time value sampling.

Thus, coordinated time values may be assigned to images obtained from different cameras 10. This can be used to compute three dimensional positions and/or orientations of objects from images of the object taken by different cameras 10. The coordinated time values may be used to select images from different cameras 10 for equal time points and/or to interpolate data from images from a camera to a time point corresponding to a time defined by an image from another camera.

As described, various tasks are performed by “the processing circuitry”, which means that it may be executed by any one or a combination of the camera control circuit 12 and the common processor 16. Thus for example, the commands to emit patterns from the light sources may originate from common processor 16, and common processor may send these commands through communication network 14 to camera control circuits 12. Alternatively, the commands may originate from one of the camera control circuit 12 and be sent to other ones of the camera control circuits 12 through communication network 14. The camera control circuits 12 perform the tasks of controlling emission of the patterns, capturing images and capturing clock time values. Each camera control circuit 12 may perform the tasks of detecting patterns from the images of its camera 10 or cameras 10, or this task may be performed by common processor 16, or by other camera control circuits 12. However, performing this task with the camera control circuit 12 of the camera 10 that captured the image has the advantage that transmission of the image over the communication network can be avoided. Similarly, the task of afterwards associating a captured clock time value with an image wherein a pattern has been detected may be performed with the camera control circuit 12 of the camera 10 that captured the image, or this task may be performed by common processor 16, or by other camera control circuits 12. Common processor 16 and camera control circuits 12 may be programmable processors, containing a program to perform the tasks as described. Part or all of the tasks may also be performed by hardware designed to perform the tasks, and located in camera control circuits 12 and/or common processor 16. Thus for example a hardware detection circuit may be provided to detect the pattern from the analog image signals.

In an embodiment, the determination of the time offsets is performed once, each time when the system is started up. In another embodiment it may be performed repeatedly, for example periodically, to update the time offsets.

In addition to, or alternative to, the determination of time offsets between different clocks, light sources 102 may also be used to determine relative camera positions. In an embodiment, the processing circuitry, e.g. camera control circuits 12, detect for each of a number of pixel locations whether emission patterns occur in the pixel values for the pixel location in a series of successive images and the processing circuitry communicates pixel location information of detected light of an identified source camera 10. Preferably, patterns of intensity variation are used that identify different source cameras 10 of the pattern. In this case, the pixel location information may be transmitted in association with an identification of the source camera 10. Alternatively, if no unique pattern is used, the source camera 10 may be made identifiable by using a time separation between indistinguishable emissions that is larger than delay variation introduced by communication network 14. However, this means that the detection takes more time.

The combination of pixel location information and source camera identification for a same source camera from a plurality of cameras 10 may be used to determine relative position information of the cameras. For example, if a first camera 10 is found to detect light emission of a pair of second cameras 10, an angle between the directions from the first camera 10 to the second cameras can be determined, which fix the position of the first camera on a two-dimensional surface defined relative to a line connecting the second cameras. This information can be used to aid determination of the relative positions of the camera. Instead of transmitting pixel positions from camera control circuit 12, images may be transmitted, in which case common processor 16 may determine the positions.

In a further embodiment at least one of the cameras comprises a plurality of light sources at mutually different positions, e.g. two light sources. In this case, detected pixel locations of the different light sources may be used to aid the determination of relative orientations of the cameras.

Although an embodiment has been shown wherein light intensity is varied between an on level and an off level, which may be the intensity of a color component of the light, it should be appreciated that other forms of modulation may be used, for example using more than two intensity levels, or by using analog modulation of the intensity or by modulating emission color instead of, or in addition to, intensity. As will be appreciated, any modulation may be used that is detectable for cameras 10. The detected modulations may be used similarly to the on-off intensity modulation.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. An image processing system comprising:
a plurality of clock circuits;
a plurality of camera units, each having an associated clock circuit from the plurality of clock circuits, each said camera unit being configured to capture images associated with clock time values captured from the associated clock circuit of the camera unit at a time corresponding to capture of the image;
a controllable light source;
processing circuitry coupled to the camera units and the controllable light source and configured to cause the controllable light source to emit modulated light, to detect the modulated light in the captured images and to determine a relative calibration of the clock circuits with respect to each other from the associated clock time values of the images, wherein the modulated light is detected.

2. An image processing system according to claim 1, wherein the controllable light source is part of one of the camera units, that camera unit being configured to capture a further clock time value from the associated clock circuit of the camera unit at a time corresponding to emission of the modulated light, the processing circuitry being configured to determine a relative calibration of the clock circuits with respect to each other from a combination of the further clock time value and the associated clock time values of the images wherein the modulated light is detected.

3. An image processing system according to claim 1, further comprising a plurality of controllable light sources, each visible from a respective group of the camera units, the processing circuitry being configured to cause each of the controllable light sources to emit modulated light, to detect the modulated light from the controllable light sources in the captured images of the groups of the cameras and to determine the relative calibration of the clock circuits with respect to each other from the associated clock time values of the images wherein the modulated light is detected.

4. An image processing system according to claim 3, wherein the processing circuitry is configured to cause each of the controllable light sources to emit the modulated light with a respective modulation pattern that distinguishes the controllable light source from all other ones of the other ones of the controllable light sources.

5. An image processing system according to claim 5, wherein the processing circuitry is configured to cause the modulation patterns of respective ones of the light sources to represent respective different codewords of an error correcting code.

6. An image processing system according to claim 3, wherein each of the camera units comprises a camera and a respective one of the light sources fixedly attached to the camera of the camera unit.

7. An image processing system according to claim 6, wherein the processing circuitry is configured to determine the relative calibration of the clock circuits with respect to each other from a combination of the clock time values of the images wherein the modulated light is detected and clock time values sampled at a time of modulation of the controllable light sources of the camera units.

8. An image processing system according to claim 6, wherein the processing circuitry is configured to cause each of the controllable light sources to emit the modulated light with a respective modulation pattern that distinguishes the light source from all other light sources, and wherein the processing circuitry is configured to calibrate relative locations of the cameras dependent on positions in the capture images where the distinguishing patterns are detected.

9. A camera unit comprising:
a clock circuit;
a camera;
a controllable light source;
a camera control circuit with a communication network interface, the camera control circuit being coupled to the clock circuit, the camera and the controllable light source, the camera control circuit being configured to control the controllable light source to emit a pattern of modulation, to sample a clock time value of the clock circuit associated with a time of emission, to sample further clock time values of the clock circuit at which further patterns of modulation are detected in images captured by the camera and to transmit information representing the sampled clock time values via the network interface.

10. A method of operating an image processing system, the method comprising:
causing a controllable light source to emit modulated light;
capturing images that contain the light source from a plurality of camera units respectively;
capturing clock time values at a time corresponding to capture of the image from respective clock circuits associated with the camera units that capture the images respectively;
detecting the modulated light in the captured images; and
determining a relative calibration of the clock circuits with respect to each other from the associated clock time values of the images wherein the modulated light is detected.

11. A method according to claim 10, further comprising:
emitting modulated light from a plurality of controllable light sources, from each controllable light source with a respective modulation pattern that distinguishes the light controllable light source from all other ones of the controllable light sources;
detecting the identify of respective ones of the controllable light sources from the modulated light captured in a succession of the captured images; and
determining a relative calibration of the clock circuits with respect to each other from groups of associated clock time values, each group for a respective one of the controllable light sources, the group for each controllable light source comprising clock time values for images wherein the modulated light for the controllable light source is detected.

12. A computer program product, comprising a program of instructions that, when executed by a programmable processing circuitry, make the processing circuitry execute the method of claim 10.
